(19) United States
(12) Patent Application Publication
(10) Pub. No.: US 2021/0180960 A1
(43) Pub. Date: Jun. 17, 2021

(54) ROAD ATTRIBUTE DETECTION AND CLASSIFICATION FOR MAP AUGMENTATION

(71) Applicant: GM Global Technology Operations LLC, Detroit, MI (US)

(72) Inventors: Dylan Verstandig, Roswell, GA (US); Michael A. Losh, Rochester Hills, MI (US); Orhan Bulan, Novi, MI (US)

(21) Appl. No.: 16/717,678

(22) Filed: Dec. 17, 2019

(51) Int. Cl. G01C 21/32; G05D 1/00; G06T 17/05; G06N 3/08; G06T 19/00; G06K 9/00; G06N 3/04

(52) U.S. Cl. CPC G01C 21/32; G05D 1/0088; G06T 17/05; G06T 2207/20084; G06T 19/006; G06K 9/00671; G06N 3/0454; G06N 3/08

(57) ABSTRACT

Systems and methods to generate an augmented map used for autonomous driving of a vehicle involve obtaining images at a first point of view, and training a first neural network to identify and classify features related to an attribute in the images at the first point of view. A method also includes projecting the features onto images obtained at a second point of view, and training a second neural network to identify the attribute in the images at the second point of view based on the features. The augmented map is generated by adding the attribute to a map image at the second point of view.

### INTRODUCTION

The subject disclosure relates to road attribute detection and classification for map augmentation.

Vehicles (e.g., automobiles, trucks, construction equipment, farm equipment, automated factory equipment) include an increasing range of autonomous operations. Autonomous operation and semi-autonomous operation (e.g., collision avoidance, adaptive cruise control, automatic braking) requires that vehicle controllers have access to information regarding the road, directions, the vehicle, and its environment. Sensors (e.g., radar system, lidar system, camera, inertial measurement unit, accelerometer) may be used to determine vehicle status and information about other vehicles or obstructions in its vicinity. A detailed map may be used to guide the vehicle along a route to a destination. When aerial images are used to generate the map that is used for semi-autonomous or autonomous operation, certain features that are occluded or unclear may negatively affect the vehicle operation. Accordingly, it is desirable to provide road attribute detection and classification for map augmentation.

### SUMMARY

In one exemplary embodiment, a method of generating an augmented map used for autonomous driving of a vehicle includes obtaining images at a first point of view, and training a first neural network to identify and classify features related to an attribute in the images at the first point of view. The method also includes projecting the features onto images obtained at a second point of view, and training a second neural network to identify the attribute in the images at the second point of view based on the features. The augmented map is generated by adding the attribute to a map image at the second point of view.

In addition to one or more of the features described herein, the obtaining the images at the first point of view includes obtaining street-level images.

In addition to one or more of the features described herein, the method also includes using one or more cameras of the vehicle to obtain the street-level images.

In addition to one or more of the features described herein, obtaining the images at the second point of view includes obtaining aerial images.

In addition to one or more of the features described herein, identifying the attribute includes identifying a road edge.

In addition to one or more of the features described herein, identifying and classifying the features is based on a type of the road edge, the features including barriers, a wall, or a change in surface.

In addition to one or more of the features described herein, the method also includes training a third neural network to identify the attribute in images at the second point of view without the features.

In addition to one or more of the features described herein, the training the third neural network includes using an output of the second neural network.

In addition to one or more of the features described herein, the training the first neural network, the second neural network, and the third neural network refers to training a same neural network.

In addition to one or more of the features described herein, the training the first neural network and the second neural network refers to training a same neural network.

In another exemplary embodiment, a system to generate an augmented map used for autonomous driving of a vehicle includes a memory device to store images at a first point of view and images at a second point of view. The system also includes a processor to train a first neural network to identify and classify features related to an attribute in the images at the first point of view, to project the features onto the images at the second point of view, to train a second neural network to identify the attribute in the images at the second point of view based on the features, and to generate the augmented map by adding the attribute to a map image at the second point of view.

In addition to one or more of the features described herein, the images at the first point of view are street-level images.

In addition to one or more of the features described herein, the system also includes one or more cameras of the vehicle to obtain the street-level images.

In addition to one or more of the features described herein, the images at the second point of view are aerial images.

In addition to one or more of the features described herein, the attribute is a road edge.

In addition to one or more of the features described herein, the features are based on a type of the road edge, and the features include barriers, a wall, or a change in surface.

In addition to one or more of the features described herein, the processor trains a third neural network to identify the attribute in images at the second point of view without the features.

In addition to one or more of the features described herein, the processor trains the third neural network using an output of the second neural network.

In addition to one or more of the features described herein, the first neural network, the second neural network, and the third neural network are a same neural network.

In addition to one or more of the features described herein, the first neural network and the second neural network are a same neural network.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that performs road attribute detection and classification for map augmentation according to one or more embodiments;

FIG. 2 is a process flow of a method of performing map augmentation through road attribute detection and classification according to one or more embodiments;

FIG. 3 is a process flow of a method of performing map augmentation through road attribute detection and classification according to one or more embodiments; and

FIG. 4 illustrates an exemplary augmented map generated according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, autonomous or semi-autonomous operation of a vehicle requires information from sensors and a map. Unlike a map used by a human driver, the map used for autonomous or semi-autonomous operation must indicate attributes that may be readily apparent to a human driver who is looking at the roadway. An exemplary one of these human-nameable attributes that is discussed herein is a road edge. Maps generated using aerial images may not clearly indicate road attributes like road edges. The features used to identify a road edge attribute may not be easily discernable because of shadows or based on the viewing angle, for example. Embodiments of the systems and methods detailed herein relate to road attribute detection and classification for map augmentation. One or more deep learning neural networks are used. Deep learning neural networks implement a type of machine learning that identifies features and classifies them.

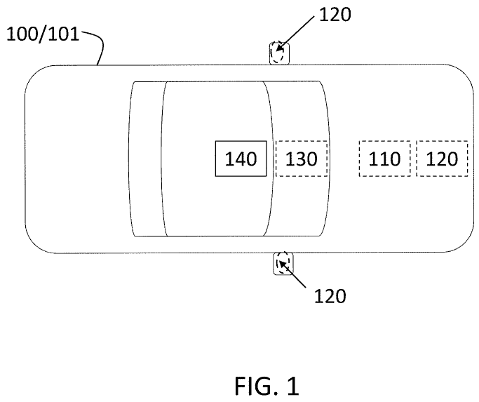

In accordance with an exemplary embodiment, FIG. 1 is a block diagram of a vehicle 100 that performs road attribute detection and classification for map augmentation. The exemplary vehicle 100 shown in FIG. 1 is an automobile 101. The vehicle 100 is shown with three cameras 120 and other sensors 140 (e.g., radar system, lidar system, vehicle operation sensors, global positioning system (GPS)) and a controller 110. The numbers and locations of the cameras 120, other sensors 140, and the controller 110 are not intended to be limited by the exemplary illustration. A user interface 130 (e.g., infotainment system) includes a display and may additionally include input mechanisms (e.g., voice input, touchscreen). The controller 110 may control operation of the vehicle 100 based on information from the cameras 120 and other sensors 140.

The controller 110 may also perform the road attribute detection and classification for map augmentation according to exemplary embodiments. According to alternate embodiments, the road attribute detection and classification for map augmentation may be performed by an outside controller based on images obtained from cameras 120 of one or more vehicles 100. The controller 110 or outside controller may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. For example, one or more memory devices of the controller 110 may store images and instructions while one or more processors of the controller 110 implement one or more neural networks discussed herein.

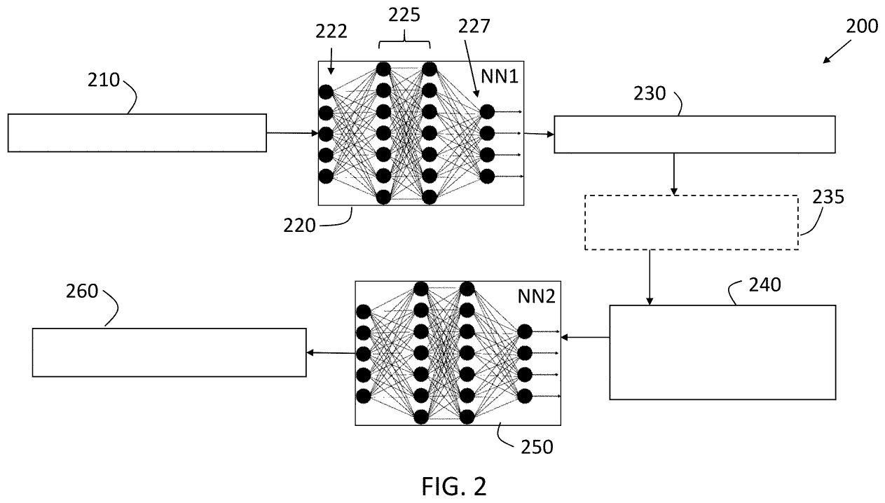

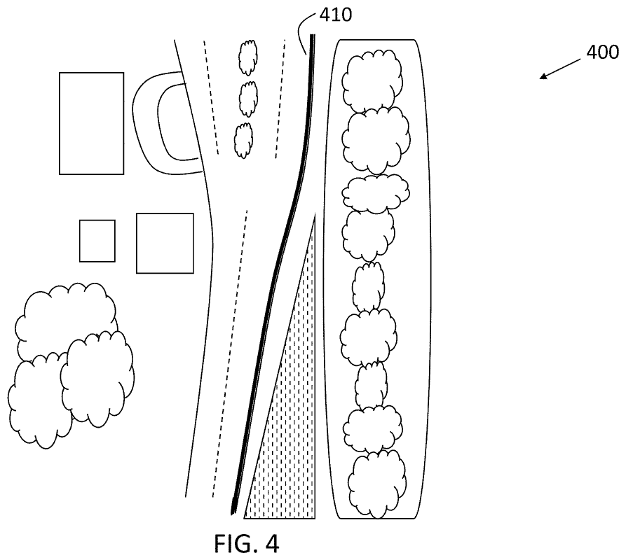

FIG. 2 is a process flow of a method 200 of performing map augmentation through road attribute detection and classification according to one or more embodiments. At block 210, obtaining street-level images includes obtaining images from one or more cameras 120 of the vehicle 100. According to an exemplary embodiment, the attribute of interest may be the road edge 410 (FIG. 4). In this case, the street-level images may be from a camera 120 on a side of the vehicle 100 known to be adjacent to the edge of the road. A number of images (e.g., 800 images) may be obtained that show road edges 410 with different features (e.g., change of surface (e.g., dirt or grass from pavement), curb, barrier, wall) at different locations. A neural network NN1 220 is trained to identify and classify features. Generally, neural network NN1 220, like any deep learning neural network, includes an input layer 222, hidden layers 225, and an output layer 227. Once trained, the neural network NN1 220 identifies and classifies features related to the attribute of interest (e.g., features related to a road edge).

At block 230, obtaining the feature classifications facilitates a determination of the location of the attribute of interest. For example, barriers at the edge of a road may be identified and classified by the neural network NN1 220. That is, the features output by the neural network NN1 220 differ based on the type of road edge. This output of the neural network NN1 220 allows the road edge 410 to be located on the street-level images. At block 235, an optional human inspection of the feature classifications output by the neural network NN1 220 may be performed. For example, a feature identification heat map may be developed by augmenting the source images (at block 210) with color-coded features identified by the neural network NN1 220. The user interface 130 may be used to facilitate the human inspection.

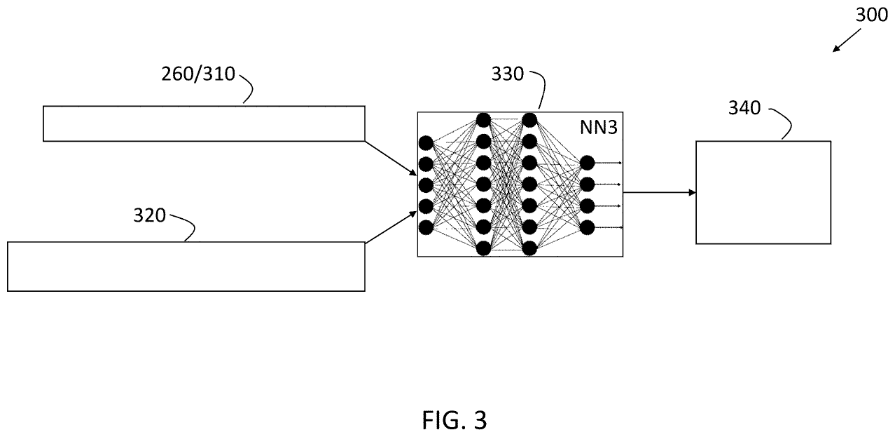

With or without the human validation (at block 235), at block 240, the features identified and classified by the neural network NN1 220 may be projected onto aerial images corresponding with the scene in the street-level images obtained at block 210. At block 250, a neural network NN2 250 is trained to use the features projected onto aerial images to output three-dimensional road edge lines used to generate an augmented map 400 (FIG. 4), at block 260. Once trained, the neural network NN2 250 translates identified features in a street-level view (or, more generally, a first point of view) to those in a corresponding aerial view (or, more generally, a second point of view). This second point of view (e.g., aerial view) corresponds to the map view. Thus, the road edge lines determined in the aerial images may be added as road edges 410 to the corresponding map view to generate the augmented map 400. Although two separate neural networks NN1 220 and NN2 250 are shown in FIG. 3, the same neural network NN1 220 may be further trained to perform the functionality discussed for both neural networks NN1 220 and NN2 250.

FIG. 3 is a process flow of a method 300 of performing map augmentation through road attribute detection and classification according to one or more embodiments. At block 310, the processes shown in FIG. 3 may begin with the augmented map 400 (FIG. 4) generated at block 260, as discussed with reference to FIG. 2. At block 320, obtaining aerial images includes obtaining un-augmented or new images. A neural network NN3 330 is trained to generate an augmented map 400 at block 340. Rules may be applied to locate the road edge attribute based on the type of road edge. For example, when the features identified and classified relate to a wall, the road edge lines that are output as part of the augmented map 400 may be on the inside of the feature locations to ensure that the vehicle 100 does not contact the wall. When the features identified and classified relate to grass, the road edge lines that are output may be at the location of the grass line. Once trained, the neural network NN3 330 can generate the augmented map 400 from aerial images without any augmentation. The neural network NN3 330 may result from further training of one of the neural networks NN1 220 or NN2 250 shown in FIG. 2.

That is, a single neural network NN1 220 may be trained to output features from street-level images obtained at block 210, trained to generate an augmented map at block 260 based on the projection of the features on aerial images at block 240, and trained to generate an augmented map at block 340 from an un-augmented aerial image obtained at block 320. Even if only a separate neural network NN3 330 is used ultimately, the neural network NN3 330 benefits from the fact that its training includes augmented maps generated at block 260 using street-level images (obtained at block 210). While street-level and aerial images are discussed for explanatory purposes, other points of view and, specifically, using images obtained with one point of view to augment images at another point of view are contemplated according to alternate embodiments.

FIG. 4 illustrates an exemplary augmented map 400 generated according to one or more embodiments. The augmented map 400 may be generated at block 260 by the neural network NN2 250 using, as input, a projection of feature classifications (at block 230) output by the neural network NN1 220. The augmented map 400 may instead be generated based on un-augmented aerial images (obtained at block 320) by the neural network NN3 330 that is trained using augmented maps (at block 260). The augmented map 400 includes an indication of a road edge 410.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of generating an augmented map used for autonomous driving of a vehicle, the method comprising:
obtaining images at a first point of view;
training a first neural network to identify and classify features related to an attribute in the images at the first point of view;
projecting the features onto images obtained at a second point of view;
training a second neural network to identify the attribute in the images at the second point of view based on the features; and
generating the augmented map by adding the attribute to a map image at the second point of view.

2. The method according to claim 1, wherein the obtaining the images at the first point of view includes obtaining street-level images.

3. The method according to claim 2, further comprising using one or more cameras of the vehicle to obtain the street-level images.

4. The method according to claim 2, wherein obtaining the images at the second point of view includes obtaining aerial images.

5. The method according to claim 1, wherein identifying the attribute includes identifying a road edge.

6. The method according to claim 5, wherein identifying and classifying the features is based on a type of the road edge, the features including barriers, a wall, or a change in surface.

7. The method according to claim 1, further comprising training a third neural network to identify the attribute in images at the second point of view without the features.

8. The method according to claim 7, wherein the training the third neural network includes using an output of the second neural network.

9. The method according to claim 7, wherein the training the first neural network, the second neural network, and the third neural network refers to training a same neural network.

10. The method according to claim 1, wherein the training the first neural network and the second neural network refers to training a same neural network.

11. A system to generate an augmented map used for autonomous driving of a vehicle, the system comprising:
a memory device configured to store images at a first point of view and images at a second point of view; and
a processor configured to train a first neural network to identify and classify features related to an attribute in the images at the first point of view, to project the features onto the images at the second point of view, to train a second neural network to identify the attribute in the images at the second point of view based on the features, and to generate the augmented map by adding the attribute to a map image at the second point of view.

12. The system according to claim 11, wherein the images at the first point of view are street-level images.

13. The system according to claim 12, further comprising one or more cameras of the vehicle configured to obtain the street-level images.

14. The system according to claim 12, wherein the images at the second point of view are aerial images.

15. The system according to claim 11, wherein the attribute is a road edge.

16. The system according to claim 15, wherein the features are based on a type of the road edge, and the features include barriers, a wall, or a change in surface.

17. The system according to claim 11, wherein the processor is further configured to train a third neural network to identify the attribute in images at the second point of view without the features.

18. The system according to claim 17, wherein the processor is configured to train the third neural network using an output of the second neural network.

19. The system according to claim 17, wherein the first neural network, the second neural network, and the third neural network are a same neural network.

20. The system according to claim 11, wherein the first neural network and the second neural network are a same neural network.
